(19) United States
(12) Patent Application Publication
(10) Pub. No.: US 2008/0277305 A1
(43) Pub. Date: Nov. 13, 2008

(54) Collectible Product

(76) Inventor: Kathy Wille, Brookfield, WI (US)

Correspondence Address: BOYLE FREDRICKSON S.C., 840 North Plankinton Avenue, MILWAUKEE, WI, 53203, US

(21) Appl. No.: 12/177,613

(22) Filed: Jul. 22, 2008

Related U.S. Application Data
(63) Continuation-in-part of application No. 29/286,299, filed on May 2, 2007.

(51) Int. Cl. B65D 83/00; C11D 17/00; B65D 85/00; B32B 37/00

(52) U.S. Cl. 206/531; 510/447; 156/280; 206/524.3

(57) ABSTRACT

A waterproof thin sticker is embedded into a top and bottom layer of soap. The sticker may be printed with a four-color image. The bottom soap layer, below the sticker, is a solid color. The bottom soap layer makes up two-thirds of the entire soap's thickness. The top soap layer, above the sticker, is comprised of clear/transparent glycerin soap and makes up one-third of the entire soap's thickness. The soap is designed to wear at the top layer first which leaves the sticker image attached to the remaining bottom soap layer. The sticker remains intact and can be peeled off from the soap, saved, and collected. Packaging includes individually wrapping the soap product in a glossy plastic wrap and then putting into windowed package such as a mailable gift box.

### CROSS-REFERENCE TO RELATED APPLICATIONS

This application is a continuation-in-part of U.S. patent application Ser. No. 29/286,299, filed May 2, 2007, the entire contents of which is incorporated herein by reference.

### BACKGROUND OF THE INVENTION

1. Field of the Invention

The invention relates to a collectible product in general. More specifically, the invention is a unique souvenir soap product with an image and specialized packaging, including a postcard box ready for mailing.

2. Discussion of Related Art

There are basically two markets for bars of soap: functional and decorative. The functional marketplace is the “traditional” soap market that produces bars of soap to be used for everyday body cleansing. However, decorative soaps are intended to compliment the “traditional” bar of soap by creating soap variations.

Decorative soaps are often produced within a so-called “cottage industry”, i.e., made to order from an individual's home. This “cottage industry” produces soaps that are costly and are not meant for mass production to be distributed to retail stores. While some companies have entered the retail market with image-based soaps, they are typically costly, have limited image capabilities, and poor packaging options which in turn causes a weak demand and short shelf-life.

Some examples of decorative soaps include surface stamping/embossing on soaps of various dimensions/shapes, soaps with decorative wrapper designs, soaps with embedded objects, soaps containing printed plastic discs, soaps with surface printed images, and formed soap designs embedded into a bar of soap. Decorative soaps that use these technologies have been around for some time.

In some soaps with images, the soap image is generally applied with a decoupage technique or by some other means of applying a decal on top of the soap. The image may then be covered with a wax material to ensure the picture lasts during usage. Unfortunately, these soaps that have printed images on the surface of the soap only have one side of soap that will be useful for washing on the skin.

Other decorative soaps exist that have embedded printed plastic discs. As these soaps wear, the disc edges stick out of the soap and the disc is very rough against the skin. Also, due to the sizable thickness of the disc, the soap layers typically split. Putting an image on plastic is costly and the image is generally not very vibrant, which causes the colors in the image to appear dull.

In other soaps, paper inserts are used. However, they wrinkle, discolor, disintegrate, and typically cannot be saved after soap usage.

Another challenge is determining soap layer ratios that make the decorative soap wear properly so that it does not split or easily fall apart. Further, eliminating fragrance in the top clear glycerin layer helps to avoid yellowing and cloudiness of image.

In other embodiments that have multiple soap layers, the image appears to be “floating” inside a bar of soap.

Still another challenge to marketing a collectible soap product is providing suitable packaging. Individually wrapping the soaps is often not enough to protect the soaps in the typical retail market. For example, glycerin soap is soft and can dent, nick, and crack easily. Glycerin soap, as currently sold in the retail marketplace, uses packaging to prevent denting, nicking, and cracking. However, when an image is embedded into glycerin soap, packaging options are limited. Because decorative soap sales rely on the ability to view the image inside the soap bar, the soaps need to be visible in the packaging and most importantly the image inside the soap must be perfectly viewable.

Another problem to making the images viewable is ensuring the packaging remains tight around the bar of soap. Many soap wrappers will loosen over time and cause the wrapper to sag. When the wrapper sags, soap residue adheres to the wrapper and the soap image becomes cloudy and distorted.

Many approaches have been taken to try to solve some of the above problems. For example, U.S. Pat. No. 6,136,764 to Bitton (the “Bitton patent”) discloses among other things images inside soap that include dissolvable paper. Dissolvable paper creates dull-looking printed images when placed inside soap. Also, non-treated paper and cardboard will wrinkle, tear, and cause water staining when placed inside soap. Since soaps are continually getting wet, moisture creates problems with paper and cardboard. However, the Bitton patent does not identify what type of paper or cardboard should be used.

The below-referenced U.S. patents disclose embodiments that were at least in-part satisfactory for the purposes for which they were intended. The disclosures of all the below-referenced prior U.S. patents in their entireties are hereby expressly incorporated by reference into the present application for purposes including, but not limited to, indicating the background of the present invention and illustrating the state of the art:

U.S. Pat. No. 4,297,228 discloses a decorated soap and a method for producing the same;

U.S. Pat. No. 5,183,429 discloses a method of manufacture of transparent soap tablets containing a child's toy;

U.S. Pat. No. 5,472,545 discloses a method for affixing labels to soap bars and labeled soap bars produced thereby;

U.S. Pat. No. 5,221,506 discloses a bar soap with structural core;

U.S. Pat. No. 6,136,764 discloses a decorative soap with an embedded dissolvable image layer;

U.S. Pat. No. 6,403,543 discloses a soap with suspended articles;

U.S. Pat. No. 5,869,437 discloses a transparent soap with dissolvable logo;

U.S. Pat. No. 6,336,553 discloses soap wrappers;

U.S. Pat. No. 5,887,410 discloses a method of molding and packaging of a novelty soap;

U.S. Pat. No D463,270 discloses soap having a gold fish in a bag;

U.S. Pat. No D423,716 discloses a fish soap;

U.S. Pat. No D506,128 discloses a transparent container with a sponge inside soaps.

Thus, what is needed is a specially packaged souvenir product, preferably including a soap bar to be sold in retail stores, and/or used for promotion or advertisement. What is also needed is a soap that has a high-quality, four color, vibrant image on a sticker inside the soap, wherein the sticker is waterproof and can be collected after soap usage.

### SUMMARY AND OBJECTS OF THE INVENTION

The present invention, in one embodiment, is a collectible soap product that includes a soap bar having a first layer of soap, a waterproof image layer adjacent to the first layer of soap, and a second layer of soap wherein the second layer of soap is transparent. The periphery of the first layer of soap preferably extends beyond the periphery of the waterproof image layer and the periphery of the second layer of soap connects to the periphery of the first layer of soap. In this manner, the first and the second layers of soap effectively surround the waterproof image layer.

The second layer of the soap bar is preferably a glycerin soap that is substantially free from fragrance oil. The first layer of soap is preferably opaque and has a thickness of about two-thirds of the thickness of the collectible soap bar. The thickness of the second layer of soap is about one-third of the thickness of the collectible soap product. The waterproof image layer may be a waterproof sticker with an image printed on a top of it in four colors.

The first layer of soap wears such that the periphery of the first layer of soap remains extended beyond the periphery of the waterproof image layer until the second layer of soap is substantially used up.

In another embodiment of the invention, the collectible soap product is individually wrapped. The soap wrapper is a transparent packaging material which preferably exhibits the following properties: glossy to enhance the appearance of the soap image, clear to reduce viewing distortion, durable to reduce ripping and tearing, moisture-free, and able to be pulled tightly over the soap bar. The packaging may further include a blister package and/or a box with a window oriented such that the waterproof image layer is at least partially viewable.

In one embodiment, the blister packaging includes at least one chamber wherein each chamber contains one of each of the soap bar and the glossy, moisture-free wrapper. In another embodiment, the packaging is a postcard box wherein the postcard box has a window oriented such that the waterproof image layer is at least partially viewable through the window.

The invention further includes a method of packaging a collectible soap product having multiple soap layers. The method includes forming the multiple-layered soap by applying a waterproof sticker to a first, opaque layer of the soap, and adding a clear layer of soap wherein the clear layer of soap adheres to the opaque layer of soap around the periphery of the waterproof sticker. The opaque layer of soap, the waterproof sticker, and the transparent layer of soap are then sealed within a glossy, moisture-free wrapper. The opaque layer of soap, the waterproof sticker, the transparent layer of soap, and the glossy, moisture-free wrapper may then be sealed in a package such as a blister package or postcard box ready for mailing.

Given the above attributes, it is one object of the invention to overcome the disadvantages of the prior art and create a functional souvenir soap that contains a perfectly viewed image that is enjoyed during soap usage and, after the soap is wasted, the image can be retrieved and collected.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages, construction, and features of the present invention will become more readily apparent by referring to the exemplary, and therefore non-limiting, embodiments illustrated in the drawings accompanying and forming a part of this specification, wherein like reference numerals designate the same elements in the several views, and in which:

FIG. 1 is a perspective view of a first embodiment of the collectible soap product.

FIG. 2 is a front view of the embodiment of FIG. 1.

FIG. 3 is a rear view of the embodiment of FIG. 1.

FIG. 4 is a top view of the embodiment of FIG. 1.

FIG. 5 is a side view of the embodiment of FIG. 1.

FIG. 6 is a perspective view of a second embodiment of the collectible soap product.

FIG. 7 is a front view of the embodiment of FIG. 6.

FIG. 8 is a rear view of the embodiment of FIG. 6.

FIG. 9 is a cross sectional view of the embodiment of FIG. 6 taken at 9-9 in FIG. 7.

FIG. 10 is a rear view of a third embodiment of the collectible soap product.

FIG. 11 is a front view of the embodiment of FIG. 10.

FIG. 12 is a side view of the embodiment of FIG. 10.

FIG. 13 is a perspective view of a fourth embodiment of the collectible soap product.

FIG. 14 is a top view of the embodiment of FIG. 13.

FIG. 15 is a front view of the embodiment of FIG. 13, showing the packaged product on display in retail outlet.

In describing the preferred embodiments of the invention that are illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

The inventive collectible souvenir product includes various embodiments having many unique features. In one embodiment, it contains a soap product with a vibrant, four-color image that is easily viewed by consumers in retail stores and during soap usage at home. Preferably, the image is carried by a thin, waterproof sticker. The sticker remains intact during soap usage and therefore can be collected when the soap is wasted.

The decorative soap bar is constructed of two soap layers and a waterproof sticker in such a manner to allow the soap to wear properly. For example, the waterproof sticker does not stick out of the soaps as the soap wears. In fact, the soaps are designed to allow the top layer of the soap to wear first. The waterproof sticker remains attached to the bottom of the soap layer until the soap is wasted or the sticker is manually removed.

Preferably, the soap product's retail shelf life is extended by applying a moisture-free soap wrapper barrier around each soap and then inserting the soaps into a specially designed package to protect and enhance the salability of the soaps. The wrapping is preferably glossy to eliminate the cloudiness of glycerin soap and to enhance the image inside the soaps, and sturdy to eliminate wrapper tearing and ripping.

In some embodiments, the product includes a “soap greeting” or mailable postcard package to contain the collectible image-based soap. The greeting or card may also be designed around a special occasion, souvenir destination, promotional theme, etc. The mailable postcard box and soap therein thus combines two items that, e.g., a tourist would purchase while on vacation, a postcard and a gift. For example, the gift includes a soap that contains an image that directly relates to a tourist destination. The image-based soap is preferably viewed through a die-cut window on the front of the box. Similarly, the postcard also may include familiar vacation images, greetings, and graphics. Additionally, the “card” or box may contain a gift tag and/or a message area to write a personal message to the gift recipient. Preferably, the back of the box is laid out like an actual postcard. Thus, the consumer can fill out the postcard and address to the recipient. Postage is then added and the postcard box is sent via mail. The recipient receives it and is thus able to enjoy both a gift and a postcard from the sender.

### 2. Detailed Description of Preferred Embodiments

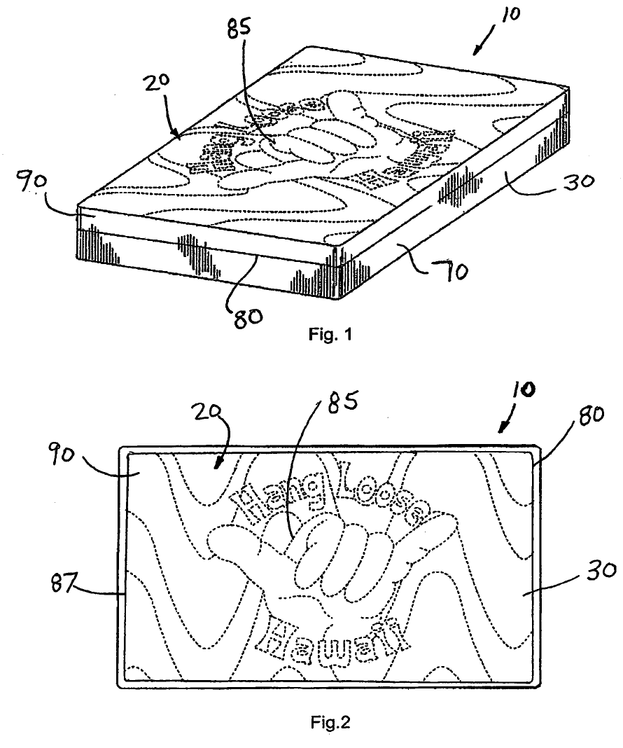

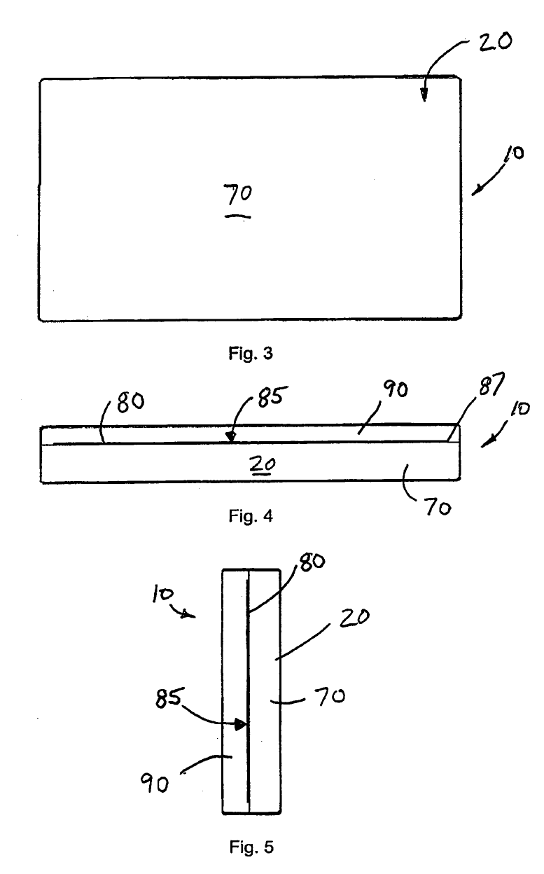

Preferred embodiments of present invention are shown at FIGS. 1-15. Each will be described in more detail below.

The embodiment of the present invention shown in FIGS. 1-5 includes a collectible product 10. Here the collectible product 10 includes a soap bar 20. The soap bar 20 preferably has an opaque bottom or first layer 70. On top of the first layer 70 is a thin, waterproof image layer, e.g., a waterproof sticker 80 having an image 85. On top of that is a second soap layer 90. The second soap layer 90 is preferably see-through or clear. In order to view the soap image without distortion, the best thickness ratio has the second or top layer 90 at ⅓ of the total thickness and the first or bottom soap layer 70 at ⅔ of the total thickness.

The soap bar 20 is designed for the top layer 90 to wear first. The clear top layer 90 may be made from a glycerin. Preferably, no fragrance is used in the top glycerin layer 90. This eliminates cloudiness due to fragrance oils because, over time, fragrance oils will cause cloudiness and yellowing of the clear layer.

It should also be noted that the edges 87 of the sticker 80 are not exposed during use of the soap bar 20. That is because the layers are configured so that the periphery of the second layer of soap 90 connects to the periphery of the first layer of soap 70, and the first and the second layers of soap surround the sticker 80.

Further, the first layer of soap 70 wears in such a way that the periphery of the first layer of soap remains extended beyond the periphery of the waterproof image layer 80 until the second layer of soap 90 is substantially used up. This is accomplished by ensuring that the length and width or circumference of waterproof sticker 80 is smaller than that of the soap layers 70, 90 to prevent the sticker from sticking out. For example, the soap layers 70, 90 may extend beyond edge 87 of the sticker 80 by ¼ of an inch. This allows top and bottom soap layers 90, 70 to adhere around the sticker 80. It also prevents the splitting of the soap bar 20 into a top layer and bottom layer.

The thicknesses and materials of the soap layers 70, 90 and sticker 80 create an image-based soap bar 20 that will wear effectively. For example, although the top layer 90 preferably wears first, the sticker 80 remains stuck to the thicker, slower wearing bottom layer 70 until the soap bar 20 is totally used. As mentioned, the sticker 80 and its edges 87 are not exposed during usage due to its dimensions and soap design.

The soap image 85 on the sticker 80 is preferably printed through four-color printing so that the image 85 is clear, vibrant, and detailed. With this construction, the image 85 appears to be printed directly into the middle of the soap. For example, the soap bar 20 resembles a high-end paper weight or flat snow globe.

Sticker 80 is preferably a thin, pliable laminate, such as a plastic or vinyl film, so that it does not disrupt the user during usage unlike existing soaps that contain objects. Examples of suitable materials for the sticker include a vinyl film manufactured by Avery Dennison and a laminate consisting of a 2 or 3 mil polypropylene layer and a 1 mil clear polyester layer. The sticker 80 may also have an adhesive on one side. Eventually in other existing soaps, the objects stick out of the soaps and are unpleasant to use. However, the inventive waterproof sticker 80 stays flat on the soap bar 20. The sticker 80 attaches to the soap layer 70 preferably by an adhesive and does not wrinkle or move within the soap bar 20. Also, the sticker 80 does not stain or distort when it gets wet. The sticker 80 will remain in place on the soap bar 20 as the soap wears away. The waterproof sticker 80 stays intact after soap bar 20 is used. Thus, after the soap life, the sticker 80 can be collected, for example, like baseball cards or souvenir magnets. The stickers may be kept in, for example, a keepsake album.

The product 10 preferably further includes a soap wrapper 30 that protects and enhances the look of the soap bar 20. The soap bar 20, including its first layer 70, waterproof sticker layer 80, and second layer 90 is individually wrapped with preferably a clear, glossy plastic wrapper that enhances the clarity of the top clear glycerin soap layer 90. In one embodiment, the wrapper 30 is pulled tightly over the soap bar 20 to enhance appeal of the embedded soap image 85. The soap wrapper 80 is moisture-proof to extend the shelf life of soap product 10. If the correct soap wrapper 30 and wrapping process is not used, vertical/horizontal lines may form in the wrapper 30 that cause soap image distortions. Further, the wrapper 30 may not stay tight and may become loose around the soap. This may create a soap film on the soap wrapper and thus image viewing is cloudy and distorted. However, the inventive soap wrapper 30 makes the image inside the soap crystal clear (like glass). Moreover, the wrapper 30 is sturdy as to not tear and break easily. In contrast, if the wrapper is too thin and flimsy, this will cause the wrapper to tear and rip.

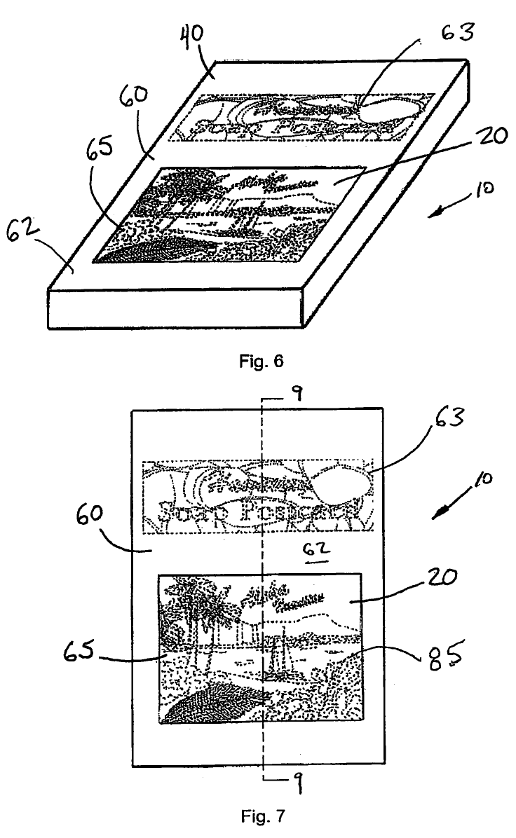

In sum, the inventive wrapper 30 must remain tightly wrapped around the soap bar so that it does not sag or let moisture in. The wrapper must also have a high gloss to enhance the soap image viewed through clear glycerin soap. Examples of suitable materials for the wrapper include a 60 gauge PVC stretch wrap or a 60, 75, or 100 gauge heat shrink film. Referring now to FIGS. 6-9, a wrapped soap product 10 is preferably placed in an additional see-through packaging 40 having a receiving chamber to further protect the product from moisture, reshaping due to heat, and denting/nicking during shipping or merchandising. The inventive packaging 40 is different than any other soap in the marketplace. This packaging preferably allows for the soap to be categorized in retail as a collectible “gift”. Therefore, the soap bar 20 can be positioned in “non-soap” aisles of the store. Of course, different soap shapes, sizes, and fragrances are possible.

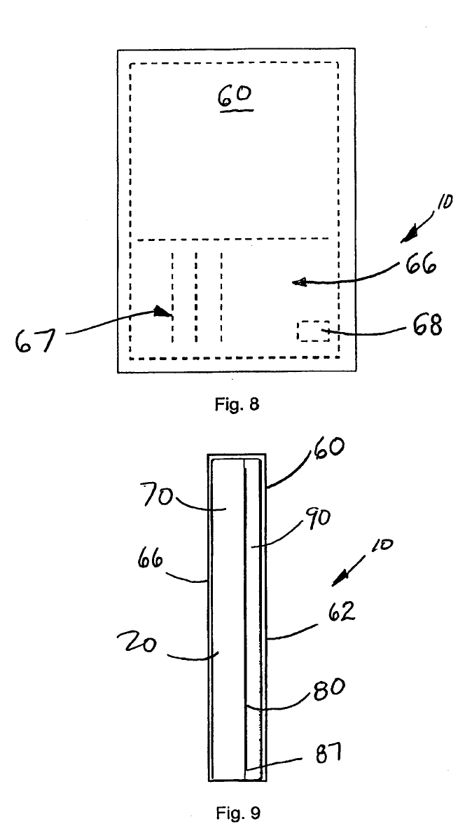

In FIGS. 6-9, the soap product 10 preferably includes a soap bar 20 and a package 40 having a receiving chamber for the soap. Here the package 40 is a box 60 that has a printed greeting or other graphics or text 63 on a first or front side 62. The opaque layer of soap, the waterproof sticker, the transparent layer of soap, and the glossy moisture-free wrapper are preferably sealed in the package 40 with the image 85 facing outward. A see-through portion or window 65 is also included in the package so that the soap bar 20 and its outwardly-facing image 85 are visible. Additionally, in the embodiment shown in FIG. 8, a back 66 of the box 60 has a postcard portion that includes an address section 67 and a place to affix a stamp 68. Of course, as one can imagine, such a “mailable” postcard box or package may be designed around any theme and may contain nearly any suitably sized “gift”. Such a “gift” may include but not be exclusive to the following: collectibles, souvenirs, coffee, candy, lotion/oils, magnets, knick-knacks, photos, or nearly any item that is sized to fit and safely sent inside the “mailable postcard box”.

In addition to the mailable postcard box 60, novel packaging 40 is at least one of: a box, a blister package, a clam shell package, and a modified container. Such a package may also be printed and further modified to include various graphic designs and text. Another example of such a package 40, a blister package 50, is shown in FIGS. 13-15.

Another embodiment, not shown, contemplates that the packaging 40 consists of clear packaging, which allows the image to be viewed, and four chambers, which each allow one wrapped soap bar 20 to be inserted therein, creating a soap gift set. The clear packaging 40 is preferably a blister type packaging of the type shown in FIGS. 13-15 with the modification that there are four chambers each shaped to hold an individual wrapped soap bar 20.

In still another embodiment, also not shown, the clear packaging could be shaped more box-like in structure with the clear packaging having a top, a bottom and four sides. The clear packaging would further have at least one chamber, and preferably four chambers, with walls extending between the top and the bottom of the clear packaging. These chambers help prevent the individual, wrapped soap bars 20 from being dented or nicked during shipping and sale.

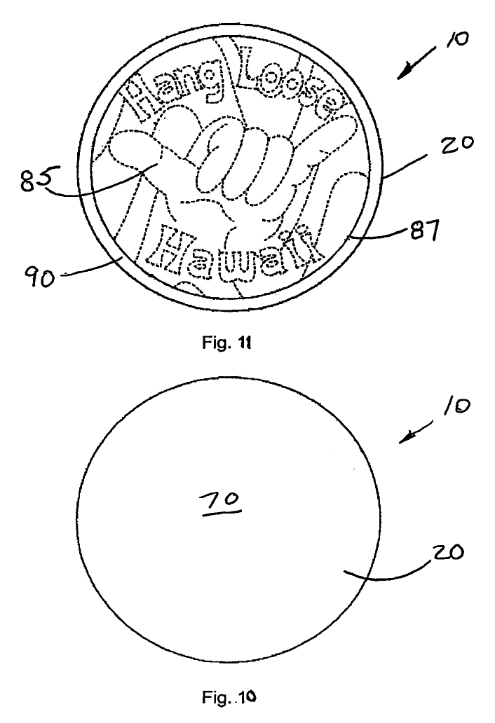

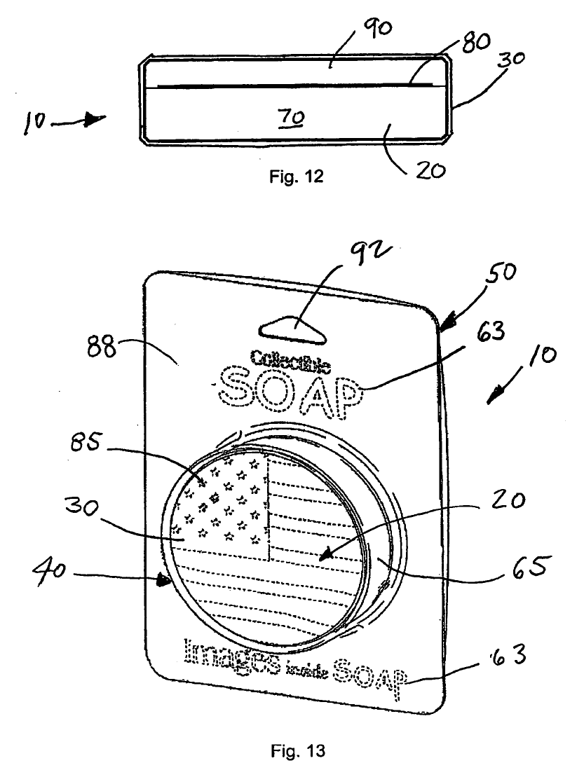

FIGS. 10-15 illustrate one method of forming and packaging the inventive product 10. Starting with FIG. 10, the bottom soap layer 70 of soap product 10 is first formed. Then, sticker 80, with a high-quality collectible image 85, is stuck to the layer 70 preferably by an adhesive as shown in FIG. 11. Next, the second or clear top layer 90 is added to completely form the soap bar 20. Wrapper 30 is then tightly wrapped around the soap bar 20 as shown in FIG. 12.

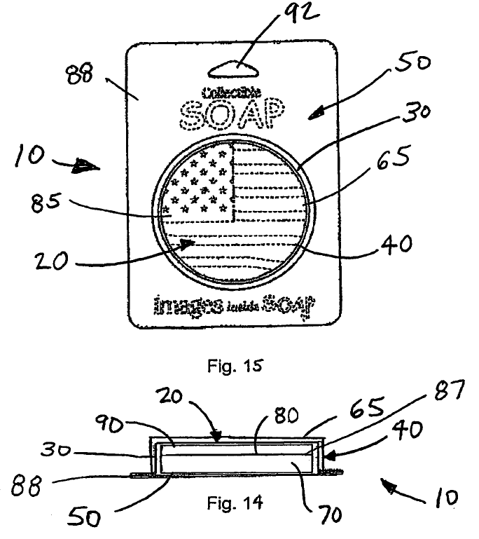

Next, packaging 40 is added to the wrapped soap bar 20 and the soap bar is sealed therein. As shown in FIGS. 14-15, the packaging 40 may further include clear blister package 50 that has card backing 88, a window 65, and a display hanger hole 92. Graphics and text 63 may appear on the card backing 88. Preferably, the image (or text) 85 on the sticker 80 of the bar 20 is visible through the window 65 in the package 50.

Alternatively, the package 40 may be a PVC container, a clamshell pack, or a clear wrap or bag (cloth/plastic/cellophane) to allow the soap to be viewed at retail stores.

As mentioned, because the soap bar 20 is neatly packaged and priced competitively in the marketplace, the collectible souvenir sticker soap may enter the retail marketplace in “non-soap” sections of retail stores and allow for soap placement in stores that traditionally do not market decorative soaps. For example, hardware, sports, and hunting retail stores traditionally have a large number of male shoppers. However, these retail stores traditionally do not market soaps. Nevertheless, the inventive collectible souvenir sticker soaps may contain a logo of an NBA, MLB, or NFL team or the photo of a favorite player. The packaging may also contain such images. Thus, as sports attract a large number of male viewers/spectators, creating such appealing images inside soaps and packaging the soaps using methods stated above will create a new retail marketplace for soap products that currently does not exist.

Moreover, by implementing the above packaging methods, the inventive collectible souvenir sticker soaps may enter the marketplace with mass marketed, functional soaps as they can be now shipped and merchandised within mass retail stores. The specialized packaging also allows for merchandise flexibility, e.g., to hang on hooks or clip strips, or to be laid on tables. Such packaging also allows for advertising of collectible souvenir sticker soaps to inform and excite consumers.

Given all of the above, the inventive image-based soaps will appeal to various markets. Some markets include:
1. Groups that have an emotional tie to consumers (e.g., NFL logo or military emblems).
2. Home décor images for kitchen and bath soaps.
3. Children's images for “tub-takers”.
4. Souvenir
5. Hotel
6. Promotional/Advertising, e.g., Harley-Davidson motorcycles, BMW automobiles, etc.
   Obviously, these are a just a few of the market possibilities.

Although the best mode contemplated by the inventor of carrying out the present invention is disclosed above, practice of the present invention is not limited thereto. It will be manifest that various additions, modifications, and rearrangements of the features of the present invention may be made without deviating from the spirit and scope of the underlying inventive concept.

For example, the sticker could be enhanced. Similarly, although cardboard and plastic is preferred for the packaging, any materials could be used. In addition, the individual soap bar components need not be fabricated from the disclosed materials, but could be fabricated from virtually any suitable materials.

Moreover, the individual components need not be formed in the disclosed shapes, or assembled in the disclosed configuration, but could be provided in virtually any shape, and assembled in virtually any configuration. Further, although the package described herein has many physically separate components, it will be manifest that they may be integrated into the nearby components. Furthermore, all the disclosed features of each disclosed embodiment can be combined with, or substituted for, the disclosed features of every other disclosed embodiment except where such features are mutually exclusive.

It is intended that the appended claims cover all such additions, modifications, and rearrangements. Expedient embodiments of the present invention are differentiated by the appended claims.

What is claimed is:

1. A collectible soap product comprising:
a soap bar including:
a first layer of soap;
a waterproof image layer adjacent to the first layer of soap wherein the periphery of the first layer of soap extends beyond the periphery of the waterproof image layer; and
a second layer of soap wherein the second layer of soap is transparent, the periphery of the second layer of soap connects to the periphery of the first layer of soap, and the first and the second layers of soap surround the waterproof image layer.

2. The collectible soap product of claim 1 wherein the second layer of soap is a glycerin soap.

3. The collectible soap product of claim 2 wherein the glycerin soap is substantially free from fragrance oil.

4. The collectible soap product of claim 1 wherein the first layer of soap is opaque.

5. The collectible soap product of claim 1 wherein the soap product has a thickness and a thickness of the first layer of soap is about two-thirds of the thickness of the collectible soap product and the thickness of the second layer of soap is about one-third of the thickness of the collectible soap product.

6. The collectible soap product of claim 1 wherein the waterproof image layer is a waterproof sticker.

7. The collectible soap product of claim 1 further comprising an image printed on the waterproof image layer in four colors.

8. The collectible soap product of claim 7 wherein the image is an image of at least one of: a team logo, a military logo, a corporate logo, and a destination.

9. The collectible soap product of claim 2 wherein the second layer of soap wears faster than the first layer of soap.

10. The collectible soap product of claim 9 wherein the first layer of soap wears such that the periphery of the first layer of soap remains extended beyond the periphery of the waterproof image layer until the second layer of soap is substantially used up.

11. The collectible soap product of claim 1 further comprising a glossy moisture-free wrapper pulled tightly over the soap bar.

12. The collectible soap product of claim 11 further comprising a transparent plastic packaging material.

13. The collectible soap product of claim 12 further comprising a blister package.

14. The collectible soap product of claim 11 further comprising a box wherein the box has a window oriented such that the waterproof image layer is at least partially viewable through the window.

15. A collectible soap product comprising:
a) a soap bar including:
a bottom layer of soap;
a waterproof image layer adjacent to the bottom layer of soap wherein the periphery of the bottom layer of soap extends about one-quarter of an inch beyond the periphery of the waterproof image layer;
a top layer of soap wherein the top layer of soap is a clear glycerin soap and the periphery of the top layer of soap connects to the periphery of the bottom layer of soap and wherein the top and the bottom layers of soap surround the waterproof image layer; and
b) a glossy moisture-free wrapper which tightly encloses the top and the bottom layers of soap.

16. The collectible soap product of claim 15 wherein the waterproof image layer is a waterproof sticker further comprising a four-color image printed on the waterproof sticker.

17. The collectible soap product of claim 15 further comprising blister packaging including at least one chamber wherein each chamber contains one of each of the soap bar and the glossy moisture-free wrapper.

18. The collectible soap product of claim 15 further comprising a postcard box wherein the postcard box has a window oriented such that the waterproof image layer is at least partially viewable through the window.

19. A method of packaging a collectible soap product comprising:
providing an opaque layer of soap;
applying a waterproof sticker to the opaque layer of soap;
adhering a clear layer of soap to the opaque layer of soap around the periphery of the waterproof sticker; and
sealing the opaque layer of soap, the waterproof sticker, and the clear layer of soap within a glossy moisture-free wrapper.

20. The method of packaging a collectible soap product of claim 19 further comprising:
enclosing the opaque layer of soap, the waterproof sticker, the clear layer of soap, and the glossy moisture-free wrapper in a see-through package.
